(19) United States
(12) Patent Application Publication
(10) Pub. No.: US 2007/0195074 A1
(43) Pub. Date: Aug. 23, 2007

(54) Method and apparatus for power management in mobile terminals

(75) Inventor: Johan Hendrik Antoon Gelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,148

(22) PCT Filed: Mar. 16, 2005
(86) PCT No.: PCT/IB05/50926

§ 371 Date: Sep. 21, 2006

Related U.S. Application Data
(60) Provisional application No. 60/555,114, filed on Mar. 22, 2004.

(51) Int. Cl. G09G 5/00

(52) U.S. Cl. 345/204

(57) ABSTRACT

A power saving management device includes a controller, a sensor (110, 111) in communication with the controller for providing status of whether or not the sensor is active. A power circuitry module is in communication with the controller and with at least one of a predetermined non-essential circuitry (127) and a display (125). The controller signals the power circuitry module to power on at least one of a predetermined non-essential circuitry and the display when an amount sensed by the sensor reaches a first predetermined threshold amount. The predetermined non-essential circuitry can include one or more of: non-essential storage or media that require either constant power or at least a periodic refreshing, including a diskette drive and a controller, a cd/dvd or other types of drives and respective controllers, expanded storage, cache storage, predetermined communication circuitry, output ports, a transmitter, and sound circuitry.

The present invention relates to apparatuses and processes designed to be conservative with power. More particularly, the present invention relates to a power management scheme for use in mobile terminals, such as PDAs (personal digital assistants), portable computers, mobile telephones, Web tablets, and Interactive Remote Controls, cameras, etc.

The field of electronic communications has been working steadily to make portable communication devices that have an ever-increasing number of functions, yet are smaller and lighter in size than previous generations of such devices. One of the limitations regarding the complexity permitted to be built into portable devices is the amount of power used. As the devices are much smaller than before, the days of permitting a device to utilize six or eight “C” or “D” size batteries are long gone. It is not uncommon that portable communication devices are powered by batteries such as Li—ION, that can be limited in power output due to their compact size, and the longer that a device can operate without the batteries being drained to the point that operability is affected is very important.

There are several areas of operation where devices use an amount of power that is more or less wasted on items that are not essential to the operation of the device, particularly when the device is not in use for a period of time. For example, certain storage that requires constant power or at least a periodic refreshing, or diskette, cd/dvd or other types of drives that are powered on with the read/write head positioned at a certain spot on the storage medium while waiting for further instructions, backlights for electronic displays, as well as key illumination on portable devices, which include but are not limited to portable computers, mobile telephones, personal digital assistants (PDAs), etc. all comprise a drain on power although they may spend a great amount of time idle.

In the case of illuminating items (such as with a backlight), which is often necessary for a user to read the screen in the dark, if control of the backlight power is left completely to the user via a switch to merely switch on or off the backlight, many will not bother to do so. Furthermore, if there are any automatic sensors that merely lighten/darken the backlight according to ambient light received, there is no indication as to whether the user is actually reading the screen.

The presently claimed invention provides a method and an apparatus to save power/prolong battery life in portable electronic devices by conserving power supplied to non-essential portions of a device.

In one aspect of the invention, a sensor (such as a light sensor, motion sensor, tilt switch), when activated, causes the device to power on from a powered off state. In a variation of the claimed invention, the device can be placed in a partially-powered mode (such as an energy/power saving mode) and can fully power on if the sensors are activated.

Conversely, if a certain period of time has passed since the sensors were last activated and the device has not been used, the device can be partially powered off by reducing power to certain non-essential hardware that does not necessarily need to be powered up while in idle. For example, certain auxiliary volatile storage (for example, RAM, DRAM, SRAM), cd/dvd drive units, diskette drive units, hard drive units, certain communication ports, output ports, audio or video displays, virtually any component of a device that requires either constant power or at least a periodic refreshing but is not essential to the operation of the device in a partial power mode) can have their input power reduced or even completely removed depending on the output of detection sensors. The device could also be completely powered down after a certain period of inactivity.

According to another aspect of the invention, there is a method and an apparatus that detect whether or not a device requires additional lighting, and at the same time, detects whether the device is in use, or is about to be in use. For example, a notebook computer, PDA or mobile telephone (it could be any electronic device, these are mere examples of some) could have both a light detector sensor for detecting ambient light, and a motion sensor. If the device is sensed as moving beyond a threshold, there can be a controller that turns on a backlight for a predetermined period of time. In addition, instead of or in addition to a motion sensor, a “tilt switch” can also be arranged in the device so that when the device is turned to a semi-horizontal position (e.g. approximately 45-75 degrees,) the switch will make contact and the backlight, or the illuminated keys will light up for a predetermined amount of time. A power algorithm may control the powering on/off of all or just select components, wherein the power algorithm is based on one or a combination of feedback readings supplied by the sensors to a controller.

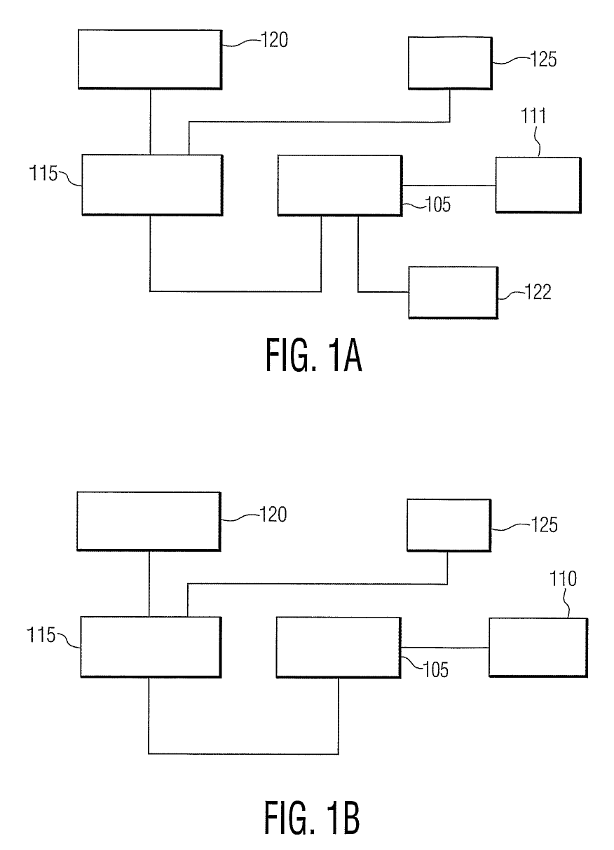

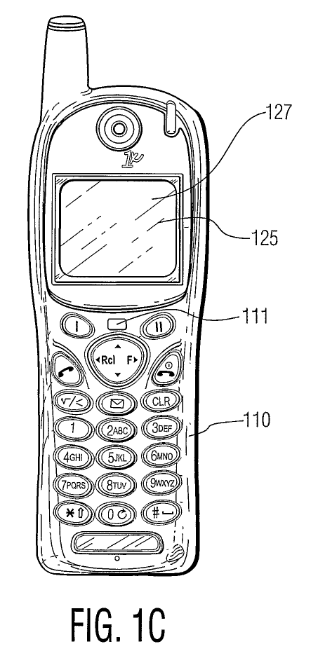

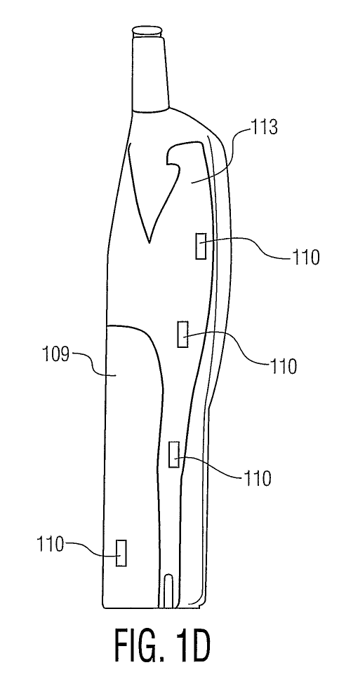

FIG. 1A is a schematic showing a first aspect of the present invention using a light sensor.

FIG. 1B illustrates a second aspect of the present invention using a pressure sensor.

FIGS. 1C and 1D are front and side views that illustrate a typical device used with the invention shown in FIGS. 1A and 1B arranged therein.

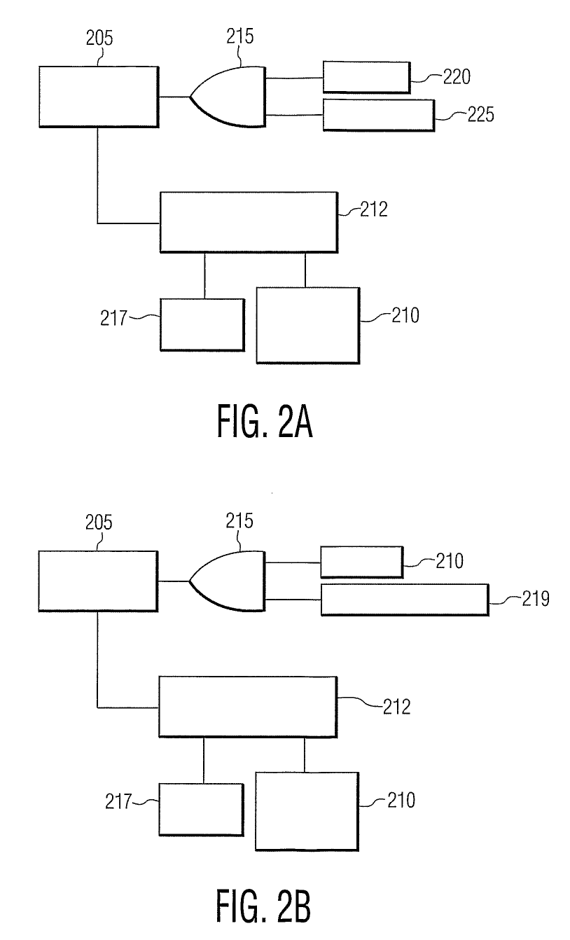

FIG. 2A illustrates a third aspect of the present invention that includes a tilt switch with the light sensor.

FIG. 2B illustrates a fourth aspect of the present invention that includes a tilt switch with the pressure sensor.

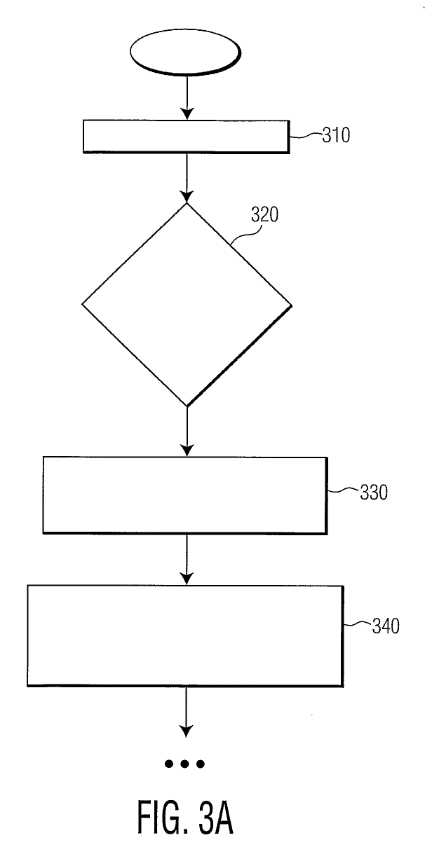

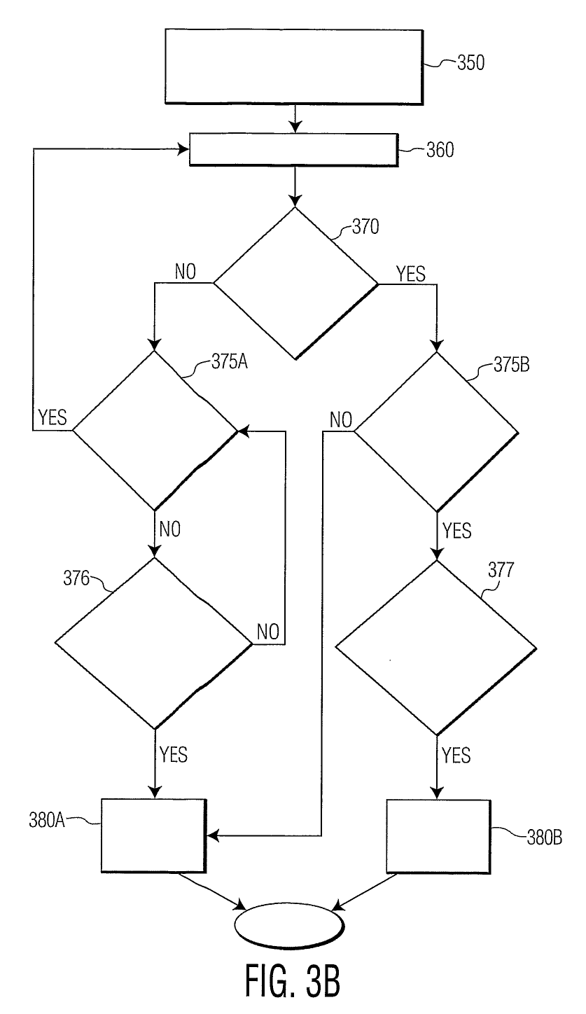

FIGS. 3A and 3B depict two flowcharts showing a method of operation of the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the finer points of the present invention.

As shown in FIG. 1A, a first aspect of the invention includes a controller 105, which is typically a microprocessor already required by the device, which monitors whether the device should be powered on or off. A person of ordinary skill in the art understands and appreciates that a separate controller could be arranged in communication with the device circuitry, but normally this would result in an increased overall size and thus costs of manufacture.

An optical sensor 111 is arranged to face upward in the same orientation as the display screen to sense ambient light, and the output of this light sensor 111 can be monitored by the controller 105 to determine whether or not the non-essential circuitry 120 of the device should be turned on. To reiterate, non-essential circuitry 120, while represented by a box, represents one or more items that are not essential to the operation of the device in an idle or reduced power state, particularly when the device has not been in use for a period of time. Such as items can include certain storage that requires constant power or at least a periodic refreshing, a diskette drive and its controller, a cd/dvd or other types of drives and their controllers, expanded storage, cache storage, certain communication circuitry, output ports, a transmitter, sound circuitry or a backlight light 127 (shown In FIG. 1C) for a display 125. These items could have reduced power (sleep mode) or no power may be provided to them.

Exactly which circuitry would remain fully powered on, or put into in a reduced power mode or powered off, would depend on the specific type of device. For example, if the device is a two-way communication device, if it is of the type where there is a ringing or beeping and the user has to manually answer, then typically the controller 105, essential storage 122 containing instruction codes, etc, the circuitry that controls switching items on and off 115, and perhaps a receiving portion, such as a receiver, that would receive a message and notify controller/microprocessor 105 that someone was attempting contact. In turn, the controller/microprocessor can direct the power on/off control circuitry 115 to turn on some or all of the non-essential circuitry that has been either totally off or in a reduced power mode.

While a backlight may permit easier reading of, for example, an LCD screen, it could be counter-productive if there is too much ambient light in the room, or a person is in sunlight. Alternatively, the optical sensor could also trigger the power on circuitry to power on the device via the controller 105. The backlight and/or display can remain powered on as long as the device is in use, for a predetermined amount of time from the sensing of the ambient light, or for a period after the usage has stopped.

It should be stressed that the power saving invention is not limited to cell phones, computers and/or PDAs, and the invention can be used in various electronic devices, such as PDA's, calculators, P.C.s, household appliances such as electric razors, irons, power tools, i.e. virtually anything that is handheld. Although FIG. 1B and FIG. 1C show the possible arrangement of a sensor in a cellphone, this is shown merely for illustrative purposes. To reiterate, the present invention in not limited to use in communication devices, and can be arranged in any type of portable device.

According to another aspect of the invention shown in FIG. 1B, there is at least one pressure sensor 110 (preferably a plurality of such sensors) that is arranged along the outer edges of a device where a person is likely to grip the device while in use. For the purposes of illustration and not limitation, it is suggested that a thin film piezoelectric (PZT) sensor, or a micro electronic mechanical sensors (MEMs) can be used. It is also possible to use electro-restrictive type sensors instead of piezoelectric sensors. While it is also certainly feasible to use optical sensors, if the device requires a case or cover (such as a leather case for a cellphone) the sensors can be darkened by the case. This problem could be overcome by designing a case/cover to have translucent or transparent edges, or possibly have openings along the edges that correspond to the position of the sensors in the device. However, if the item is commonly carried in a pocket, such as a cellphone, the lack of ambient light could falsely trigger the device to power on, wasting energy.

According to this aspect of the invention, when the portable device is held by a user, his/her fingertips exert a certain pressure against the device. In one particular example, when someone is holding a calculator, computer, PDA, power tool, cellphone, etc., it is presumed that the person desires to use the device. Thus, the sensors 110 have a predetermined pressure threshold associated with an amount of pressure typically exerted by a user. When this threshold amount is exceeded, the sensor 110 then notifies the controller 105 that a predetermined amount of pressure has been sensed. The controller 105, in turn, activates the power on circuitry of the device 115, for example, by sending a “power on” signal or message. In turn, the non-essential circuitry 120 and/or display 125 that were previously in a powered off or low-power state, are turned on by the power on circuitry unit 115.

The pressure sensor 110 can be set to have a threshold that requires the person to “squeeze” a portion of the device to cause it to power on. This feature would save the device from attempting to power on and off every time someone merely picked up the device to move it to another room, their coat pocket, etc.

Alternatively, or in addition thereto, the pressure sensor could also be used to permit the controller to count a certain amount of time that pressure is applied before powering on the device. For example, the controller 105 may count a certain predetermined number of seconds that the sensor is signaling pressure being sensed, and after that the device would automatically power on, or the backlight 127 for display 125 (shown in FIG. 1C) would automatically come on. Alternatively, if the pressure is no longer sensed, after a predetermined threshold count, portions of the device could then be powered down, or reduced in power, for example, in a “sleep” mode.

As shown in FIGS. 1C and 1D, it would be preferable to arrange a plurality of sensors 110 that can detect pressure along areas of the device where a person would normally hold it. While there are different types of pressure sensors that could be used, preferably an array (of thin-film PZT for example) can be arranged along edges of the device, as people may grab the device at different areas.

As shown in the example illustrated in FIGS. 1C and 1D, in this particular case, it is recommended that the pressure sensors 110 be arranged on two sides of the device. One reason this arrangement is preferable is because the device is sufficiently small enough that it is normally held with just one hand, and if a person dials with their left hand, they would hold the device with their right hand such that their four fingers would be somewhere along the left edge of the device and their thumb along the right edge of the device. In contrast, a person dialing with their right hand would hold the device with their left hand, and they would have four fingers pressing against the right side of the device and their thumb on the left side of the device. However, it is clearly within the spirit and scope of the invention that the sensors can be put on one side. Again, it is stressed that the invention is not limited to cellphones or telephone of any kind, as the device that uses the invention to power off non-essential circuitry is virtually unlimited in scope, and just a few of such examples where it can be used includes hand-held power tools, computers, calculators, test equipment, etc., etc.

Although sensors 110 can be arranged on the front or the back of the device as well, an artisan appreciates that depending on the device it may not be practical to do so. For example, in the depicted case of a cellular telephone, it is not uncommon for such devices to be placed on a table or a desk with their face oriented upward. The weight of the device pressing downward might trigger sensors arranged in the back of device, unless the threshold is set to be greater than the pressure typically exerted when the object is placed on a table, etc. Moreover, if the device is relatively thin, such as a calculator, the back of the device may rest against a user's palm, and is gripped along the sides.

To reiterate, instead of the controller 105 powering on/off portions of the entire device by the power on/off circuitry 115, it is possible that the device is in a “sleep mode” where it isn't entirely powered off, as some basic monitoring functions or sensors for same may still be receiving power. For example, a large draw on batteries tends to be items such as the display and the storage associated with such display. Thus, when the pressure sensor 110 detects a certain pressure is at threshold, the controller may turn on/off the backlight 127 of the device or power on/off the entire display 125.

The determination as to how the long the device remains powered on can be dependent upon conventional power saving mode features, such as a timer that counts a certain amount of time without keys being touched or a message being sent/received, and then powers down the device, or shuts off the backlight 127, the entire display 125, or the entire device.

There are similar relevant issues when using optical sensors to turn on or off the backlight as there are in the case of optically detecting fingers/hands holding the device. Otherwise such a device might actually use more power rather than save from powering on in dark areas, such as a person's coat pocket, unless the device or its case is designed with an ambient light sensor 130 in mind. For example, the case could have a shade comprising an additional piece of leather with Velcro on one edge that covers the screen or the sensor, and when the person goes to use the telephone he/she would pull the shade back and expose the sensor to ambient light. This exposure to light could control powering up and down of the device, for example.

FIGS. 2A and 2B illustrate different variations of the claimed invention. The device shown in FIG. 2A does not use a pressure sensor at all. A sensor 220, which may be arranged similarly as the light sensor 130 shown in FIG. 1B, or it may comprise a pressure sensor, a temperature sensor, or even a sound sensor, is logically arranged with a tilt switch 225 in the device. Items such as calculators, computers, cell phones, etc., are normally resting vertically or horizontally. However, when they are picked up and held by a user to be typed on, activated, spoken to (Such as a voice activated recorder), dialed, they tend to be held at an acute angle from the horizontal, somewhere on order of 30-75 degrees or so.

In order to prevent the non-essential circuitry 210 from powering on unnecessarily, or the power on circuitry 212, the light sensor 220 and the tilt switch 225 are logically “anded” by AND gate 215.

By requiring both the tilt switch 225 to be active and the sensor 220 to detect the present of ambient light, the device will not be unnecessarily powered on when placed inside a person's jacket or briefcase. Even if the device switches positions, the fact that there is darkness in the person's coat would serve to keep the output of AND gate 215 a logic zero.

It should be noted that while an AND gate was shown, any Boolean logic equivalent can be used. A series of XORs, ORs, NANDs, Inverters, etc. could be used as a group or in a specific combination that would result in the outputs of the light sensor 220 and tilt switch 225 being tied together to prevent unnecessary power ons. Similarly, after a certain period of time, if the device is not being actively used and it is sensed that, for example, the device is no longer tilted, the controller 205 could either turn off/reduce power to the non-essential circuitry 210 and/or display 217, put the device in a sleep mode, and/or signal the power circuitry 212 to power down the device (etc.). Regardless of the position of the tilt switch, after a certain period of non-use, the device may be programmed to power down.

FIG. 2B illustrates another aspect of the invention. In this particular aspect, the sensor 220 is “anded” with pressure sensor 219, and only when there is both sensed ambient light and sensed pressure would the controller 205 begin a power on sequence, or turn on the non-essential circuitry 210 and/or the display 217 on.

Finally, FIGS. 3A and 3B provide an overview of a method according to the present invention. This method can be used as an algorithm on a computer readable medium that monitors power usage. Again, although a device sensing light is the type of portable device used in the invention, it is stressed that the claimed invention is not limited to such types of devices. For this particular aspect of the invention, it is presumed that the device is either powered off or is in a less than normal power state, such as a sleep mode. The sensor may comprise a photo-voltage transducer to supply a signal to the controller, or power on/off circuitry, when sufficient light is sensed.

At step 310, the sensor detects ambient light. One possible example is that the user took the device (in this case a telephone) out of a coat pocket.

At step 320, it is determined whether the light has crossed a threshold. The threshold may be one or a combination of brightness and time.

At step 330, the threshold of sensed light has been exceeded, and the sensor signals the controller/microprocessor of the sensed light.

At step 340, the controller/microprocessor signals the power on/off circuitry of the sensed light.

At step 350, the controller/microprocessor requests power on/off circuitry to power on at least one of a display or backlight. It is possible that both are requested powered on, if the ambient light sensed, while bright enough to cross a threshold, is still not bright enough that the display is readily visible without the backlight. It should be understood by a person of ordinary skill in the art that the backlight would not be turned on unless the display was already on. Also the powering on of the display should include fully powering on the device, if it is not already powered on, or awaking the device from “sleep mode”.

At step 360, the sensor continues to detect ambient light. At step 370, a determination is made regarding the results of this detection. If ambient light is no longer detected (meaning the device may be in the dark or nearly dark environment) in order to save power, the display and/or backlight can be powered off.

Thus, if the answer to step 370 is that ambient light is no longer detected, at step 375A it is determined whether or not the device is still in use. If the device is still in use, the detection continues without affecting the operation of the display or the backlight. However, if the device is not in use, at step 376 it is determined how much time has passed. When the amount of time passed reaches a predetermined threshold amount, at step 380 the microprocessor/controller either powers off the device to save energy from being wasted, or reduces power to non-essential circuitry. Alternatively, the microprocessor/controller may just power down the display, or may reduce the power sufficient to activate a sleep mode throughout the device.

On the other hand, if it is determined at step 370 that the ambient light is still detected, it is determined at step 375B whether or not the device is still in use. If the device is still in use, at step 377 it is determined whether the ambient light is still greater than a threshold amount required to view the device display without a backlight. If the answer is yes, at step 380B the backlight will be powered off (step 380B) if the amount of detected light is sufficient for the display to be viewed without the backlight turned on.

Should the invention include a tilt switch and a light sensor, then the decision boxes in the method steps would make a two-step determination, i.e. whether the sensor detects ambient light and whether the tilt switch is active.

In addition, if the invention uses a pressure sensor, the decision boxes in the method steps would ask whether the pressure detected by the user's hand was sufficient to trigger the power on/off circuitry. Furthermore, for example, at step 375B, there can be a determination as to whether the device is not in use (idle) for a period of time. Once, for example, a minute has passed and the user has not touched the keyboard that could be a trigger to power down at least the display.

Various modifications can be made to the present invention by a person of ordinary skill in the art that do not depart from the spirit of the invention or the scope of the appended claims. For example, the sensors may sense light, pressure, tilting of the device, and can comprise piezoelectric arrays, PZT, MEMS, conventional pressure switches, all of which are preferably disposed on common areas where the device is held, used or gripped. Other types of switches, sensors, can also be used. The device is not limited to a telephone, PDA, or computer and may comprise any handheld device, including but not limited to, power tools, flashlights, calculators, etc. The device could be modified so that a handle is attached to the device to permit powering on and off by simply squeezing the handle.

1. A power saving management device comprising:
a controller;
a light sensor in communication with said controller 105 for providing status of whether or not light is sensed by the sensor; and
a power circuitry module in communication with the controller and with at least one of a predetermined non-essential circuitry and a display,
wherein the controller signals said power circuitry module to power on said at least one of a predetermined non-essential circuitry and the display when an amount of light sensed by the light sensor reaches a first predetermined threshold amount.

2. The device according to claim 1, wherein the non-essential circuitry comprises one or more of predetermined non-essential circuitry comprising: non-essential storage or mediums that require either constant power or at least a periodic refreshing, including a diskette drive and a controller, a cd/dvd or other types of drives and respective controllers, expanded storage, cache storage, predetermined communication circuitry, output ports, a transmitter, and sound circuitry.

3. The device according to claim 1, wherein the non-essential circuitry comprises a backlight, and the controller signals said power circuitry module to power on said backlight when an amount of light sensed by the light sensor is greater than or equal to a first predetermined threshold amount but less than a second predetermined threshold amount that is higher than said first predetermined amount.

4. The device according to claim 3, wherein the controller signals said power circuitry module to power off said backlight when an amount of the light sensed by the light sensor is greater than the second predetermined threshold amount.

5. The device according to claim 1, wherein the controller signals said power circuitry module to power off the display if an amount of light being sensed by the sensor goes below the first predetermined threshold amount.

6. The device according to claim 1, further comprising a tilt switch arranged so that the controller signals the power circuitry module to power on when the device is oriented at an angle greater than zero degrees and less than ninety degrees.

7. The device according to claim 1, wherein the controller determines whether a device is still in use when an amount of light sensed by the light sensor goes below the first predetermined threshold, and powers off the display if it is determined that the device is not in use for a predetermined amount of time subsequent to the light sensed dropping below said first predetermined threshold amount.

8. The device according to claim 1, wherein the controller determines whether a device is still in use regardless of whether or not when an amount of light sensed by the light sensor goes below the first predetermined threshold, and the controller signals the power circuitry module to power off the display if it is determined that the device is not in use for a predetermined amount of time.

9. A power saving management device comprising:
a controller;
a pressure sensor in communication with said controller for providing status of whether or not light is sensed by the sensor; and
a power circuitry module in communication with the controller and with at least one of predetermined non-essential circuitry and a display,
wherein the controller signals said power circuitry module to power on at least one of said predetermined non-essential circuitry and said display when an amount of pressured sensed by the pressure sensor reaches a first predetermined threshold pressure amount.

10. The power saving management device according to claim 9, further comprising:
a base;
two sides arranged at a substantially perpendicular angle to the base;
wherein the pressure sensor is arranged against one of the two sides at a location wherein a user is likely to grip the device; and
wherein the pressure sensor is adapted for detecting a change in pressure against at least one of the two sides when gripped by a user.

11. The device according to claim 10, further comprising a plurality of sensors arranged substantially along the two sides of the device.

12. The device according to claim 11, wherein the plurality of sensors comprise piezoelectric thin film (PZT) sensors.

13. The device according to claim 11, wherein the plurality of sensors for at least one side are arranged in an array.

14. The device according to claim 11, wherein the plurality of sensors comprise electro-resistive sensors.

15. The device according to claim 11, wherein the plurality of sensors comprise Micro-Electromechanical Systems (MEMS) sensors.

16. The device according to claim 10, further comprising a face arranged opposite to said base and substantially perpendicular to the two sides, and wherein the display is arranged therein.

17. The device according to claim 16, further comprising a sensor arranged on a face of the device, said sensor being in communication with said controller and an output of said sensor and an output of said pressure sensor being respectively connected to inputs of a logic AND gate, so that the controller signals said power circuitry module to power on said display only when both an output sensed by the sensor and an output of pressure sensed by said pressure sensor is greater than or equal to their respective first predetermined threshold amounts.

18. The device according to claim 17, wherein the controller signals said power circuitry module to power partially power on said predetermined non-essential circuitry when an amount sensed by the sensor is greater than or equal to a first predetermined threshold, and to fully power said predetermined non-essential circuitry when an amount sensed is a second predetermined threshold amount that is higher than said first predetermined amount.

19. The device according to claim 18, wherein the controller determines whether a device is still in use when an amount sensed by the sensor goes below the first predetermined threshold, and powers off the display if it is determined that the device is not in use for a predetermined amount of time subsequent to the sensed amount dropping below said first predetermined threshold amount.

20. A method for managing the saving of power in a device, comprising the steps of:
(a) determining by a sensor whether a light has exceeded a threshold level of brightness;
(b) signaling by the sensor to a controller/microprocessor that the light sensed in step (a) has exceeded a threshold;
(c) signaling by the controller/microprocessor signals to a power on/off predetermined non-essential circuitry about the sensed light;
(d) requesting by the controller/microprocessor to the power on/off circuitry to power on at least one of a display or the predetermined non-essential circuitry;
(e) determining whether the light sensed by the sensor continues to exceed the threshold level of brightness;
(f) determining whether or not the device is still in use if the light sensed by the sensor in step (e) no longer exceeds the threshold level of brightness; and
(g) powering off the display and/or the non-essential circuitry powered on in step (d) to save power if the detected light no longer exceeds the threshold level and it has been determined in step (f) that the device is not in use.

21. A method for managing power savings in a device, comprising the steps of:
(a) providing status of whether an output is active of a pressure sensor in communication with a controller;
(b) providing a power circuitry module in communication with the controller with at least one of predetermined non-essential circuitry and a display; and
(c) signaling by the controller to the power circuitry module to power on the display when an amount of pressured sensed by the pressure sensor reaches a first predetermined threshold pressure amount.

22. The power saving management method according to claim 21, further comprising the sub-steps in step (a) of:
(a) providing a base;
(b) arranging two sides at a substantially perpendicular angle to the base;
(c) arranging the two sides wherein the pressure sensor is adjacent at least one of the two sides at a location wherein a user is likely to grip the device; and
(d) detecting a change in pressure against at least one of the two sides when gripped by a user.
